(19) United States
(12) Patent Application Publication
(10) Pub. No.: US 2026/0336088 A1
(43) Pub. Date: Oct. 29, 2026

(54) DIE RETENTION SYSTEMS AND METHODS FOR A HYDRAULIC TOOL

(71) Applicant: Milwaukee Electric Tool Corporation, Brookfield, WI (US)

(72) Inventors: Sean Casey, Brookfield, WI (US); Kimberly S. Ackley, Brookfield, WI (US)

(21) Appl. No.: 19/655,364

(22) Filed: Apr. 22, 2026

Related U.S. Application Data
(60) Provisional application No. 63/796,579, filed on Apr. 29, 2025.

(51) Int. Cl. B25F 5/00

(52) U.S. Cl. CPC B25F 5/005

(57) ABSTRACT

A die retention system for a hydraulic tool includes a jaw defining a thru-hole extending from a first side to a second side of the jaw, a pin moveably retained within the thru-hole, a biasing element arranged within the thru-hole, and a dowel rod installed through the pin. The pin is movable between a first position and a second position via interaction between a portion of a die and a ramped surface of the pin. The biasing element applies a biasing force to the pin to maintain the pin in the first position. The dowel rod retains the pin within the thru-hole.

### CROSS-REFERENCE TO RELATED APPLICATIONS

This application claims priority to U.S. Provisional Application No. 63/796,579, filed Apr. 29, 2025, which is hereby incorporated by reference in its entirety.

### BACKGROUND

Hydraulic tools (e.g., hydraulic crimper/cutter tools) typically include a head with one or more jaws. In some examples, depending on the intended use case, the jaws may include a crimping or cutting die. In some examples, the die may be secured to the jaws with fasteners. However, typical installation methods for installing the die may require two-handed operation, which may be undesirable to operators.

### SUMMARY

According to one aspect of the present disclosure, a die retention system for a hydraulic tool can include a jaw defining a thru-hole extending from a first side to a second side of the jaw. A pin can be moveably retained within the thru-hole. The pin can be movable between a first position and a second position via interaction between a portion of a die and a ramped surface of the pin. A biasing element can be arranged within the thru-hole to apply a biasing force to the pin to maintain the pin in the first position. A dowel rod can be installed through the pin to retain the pin within the thru-hole.

In some examples, the thru-hole may include an internal ledge, and the biasing element may be positioned between the internal ledge and a retention ledge of the pin.

In some examples, the pin may include a body and a head, the body defining a slot to receive the dowel rod.

In some examples, the slot may include a first end and a second end, the first end contacting the dowel rod when the pin is in the first position, and the second end contacting the dowel rod when the pin is in the second position.

In some examples, the body of the pin may include a keyed end to mitigate rotation of the pin within the thru-hole.

In some examples, the keyed end may have at least one planar side.

In some examples, the biasing element may be a spring.

In some examples, the pin may secure the die to the jaw when in the first position and may permit removal of the die from the jaw when in the second position.

In some examples, the pin may include a travel stop having a ridge configured to contact the internal ledge of the thru-hole to mitigate over-travel of the pin when in the second position.

In some examples, the die may include one or more fingers defining a mouth, and the one or more fingers may be configured to interact with the ramped surface to move the pin from the first position to the second position during installation of the die.

According to another aspect of the present disclosure, a method of installing a die onto a jaw of a hydraulic tool can include aligning the die with a ramped surface of a pin moveably retained within a thru-hole of the jaw. The method can include applying a force to the die to cause the die to contact the ramped surface and move the pin from a first position within the jaw to a second position within the jaw, against a biasing force of a biasing element. Once the die is seated on the jaw, the method can include moving the pin from the second position to the first position via the biasing force from the biasing element to secure the die to the jaw.

In some examples, aligning the die may include aligning one or more fingers of the die with the ramped surface of the pin.

In some examples, the pin may be retained within the thru-hole by a dowel rod installed through a slot in the pin.

In some examples, the slot may include a first end and a second end, the first end contacting the dowel rod when the pin is in the first position, and the second end contacting the dowel rod when the pin is in the second position.

In some examples, the biasing element may be a spring positioned between an internal ledge of the thru-hole and a retention ledge of the pin.

According to yet another aspect of the present disclosure, a die retention system for a hydraulic tool can include a jaw defining a thru-hole extending from a first opening on a first side of the jaw to a second opening on a second side of the jaw. The thru-hole can include an internal ledge on an internal surface of the thru-hole. A pin can be moveably retained within the thru-hole. The pin can include a body and a head, the body defining a ramp assembly having one or more ramps and a slot. The pin can be movable between a first position and a second position via interaction between a portion of a die and the one or more ramps. A biasing element can be arranged within the thru-hole and positioned between the internal ledge and a retention ledge of the pin to apply a biasing force to the pin to bias the pin into the first position. A dowel rod can be installed through the slot of the pin to retain the pin within the thru-hole.

In some examples, the slot may include a first end and a second end, the first end contacting the dowel rod when the pin is in the first position, and the second end contacting the dowel rod when the pin is in the second position.

In some examples, the body of the pin may include a keyed end having at least one planar side to mitigate rotation of the pin within the thru-hole.

In some examples, the pin may include a travel stop having a ridge configured to contact the internal ledge of the thru-hole to mitigate over-travel of the pin when in the second position.

In some examples, the die may include one or more fingers defining a mouth, and the one or more fingers may be configured to interact with the one or more ramps to depress the pin from the first position to the second position during installation of the die.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a diagrammatic view of an example hydraulic tool including a die retention system according to aspects of the present disclosure.

FIG. 2 is a side view of an example of the hydraulic tool of FIG. 1 including an example die retention system.

FIG. 3 is a first side view of the die retention system of the hydraulic tool of FIG. 2.

FIG. 4 is a cross-sectional view of the die retention system of FIG. 3.

FIG. 5 is a second side view of the die retention system of FIG. 3, with a jaw rendered transparent for ease of illustration.

FIG. 6 is a side view of the die retention system of FIG. 3.

FIG. 7 is a side view of a pin of the die retention system of FIG. 6.

FIG. 8 is a cross-sectional view of the die retention system of FIG. 3 in a first position.

FIG. 9 is a cross-sectional view of the die retention system of FIG. 3 in a second position.

FIG. 10 is an axonometric view of the die retention system of FIG. 3, with a die partially installed.

FIG. 11 is an axonometric view of another example of a die retention system for use with the hydraulic tool of FIG. 1.

FIG. 12 is a cross-sectional view of the die retention system of FIG. 11.

FIG. 13 is an axonometric view of yet another example of a die retention system for use with the hydraulic tool of FIG. 1.

FIG. 14 is a cross-sectional view of the die retention system of FIG. 13.

FIG. 15 is an end view of the second end of the pin of FIG. 7.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

In some examples, the die retention system of the present disclosure provides secure and efficient installation and removal of dies on a hydraulic tool. In some examples, the die retention system includes a pin, a biasing element, and a dowel rod, which may be housed within a thru-hole in the jaw of a working head of the hydraulic tool. In some examples, the pin includes a body with multiple portions of different diameters and a head. In some examples, the die retention system facilitates one-handed installation of the die, but requires two-handed operation for die removal, reducing the risk of accidental detachment during operation.

In some examples, the pin includes a ramp assembly, which defines one or more ramps and a slot for the dowel rod. In some examples, the ramp assembly permits installation of the die by interacting with a portion of the die to depress the pin. Further, the ramp assembly provides a secure locking mechanism once the die is installed. Working in conjunction with the ramp assembly, the biasing element (e.g., a spring) automatically returns the pin to a home position after installation of the die.

In some examples, the die retention system incorporates a travel stop on the pin body, which prevents over-travel of the pin. Additionally, the system employs a keyed design at a second end of the pin to mitigate rotation of the pin. This keyed design, which may take the form of a single flat side, a double-D shape, or other non-circular cross-section, mitigates unwanted rotation of the pin within the jaw.

In operation, the die retention system transitions between a first position and a second position. In the first (e.g., home) position, the biasing element exerts force on the pin. When installing a die, a portion of the die interacts with the ramps, moving the system to the second (compressed) position. This movement compresses the biasing element and permits the die to slide into position. Once the die is in position, the biasing element automatically returns the system to the first position, securely locking the die in place.

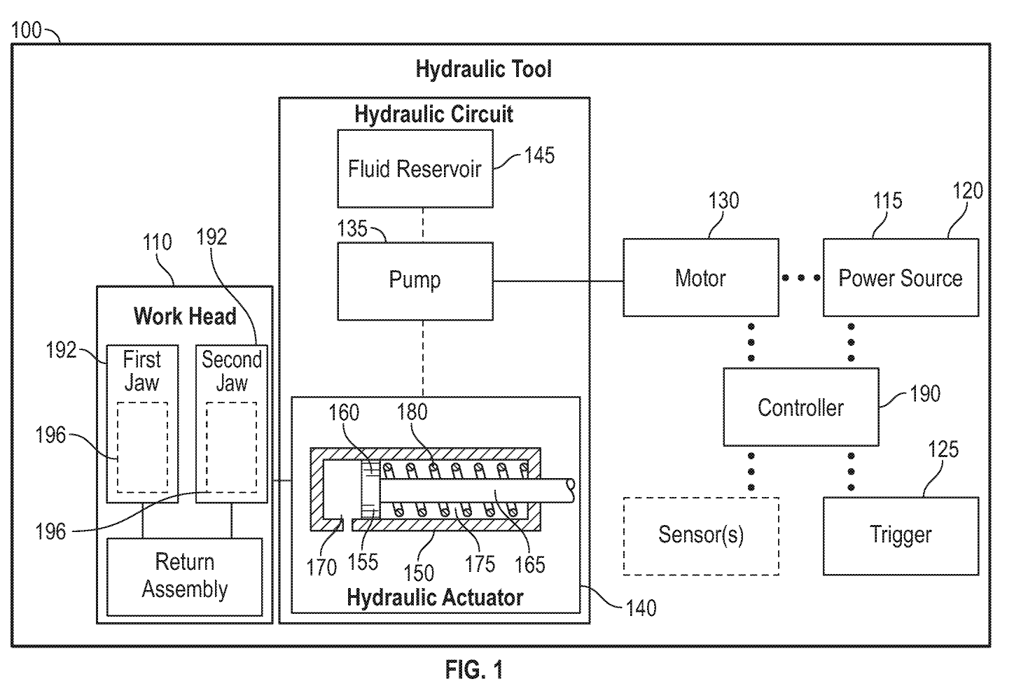

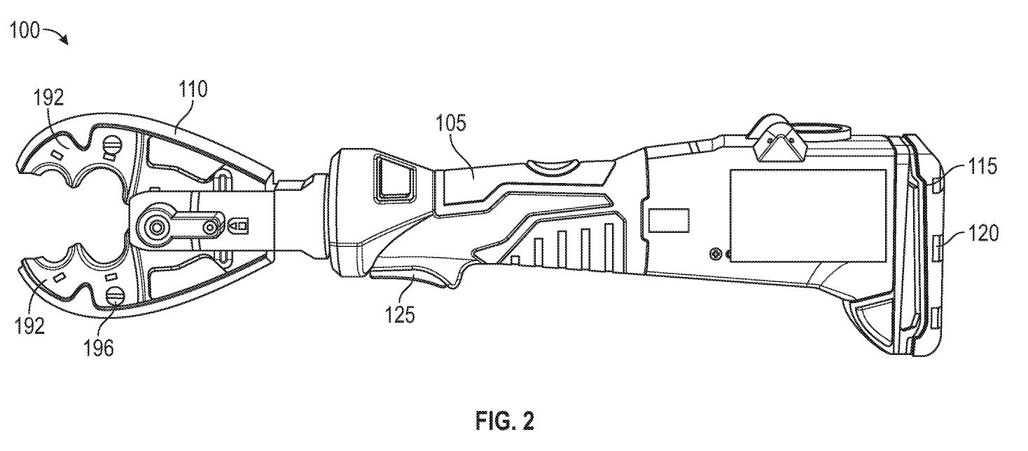

FIGS. 1 and 2 illustrate an example of a hydraulic tool 100. Although the example implementation described herein references a crimpling/cutting tool, the features of this disclosure can be implemented in other similar tools, such as shearing tools or punching tools. In addition, any suitable size, shape, or type of elements or materials could be used. The illustrated hydraulic tool 100 includes a housing 105 and a working head 110 (e.g., including one or more jaws) that is coupled to the housing 105 to perform an operation (e.g., crimp, cut, etc.) on a work piece. In some examples, the hydraulic tool 100 may include a power source 115 in order to permit operation of the tool 100. In some examples, the tool 100 can be battery-operated and the power source 115 may be in the form of a battery 120 (e.g., a removable, rechargeable battery). In other examples the hydraulic tool 100 can be include a power cord (e.g., for alternating current (AC) power connections).

To operate the hydraulic tool 100, a trigger 125 may be coupled to the housing 105. The trigger 125 can be manipulated by a user to actuate the hydraulic tool 100 and perform the work operation. For example, actuating the trigger 125 can control operation of an output assembly that is disposed within the housing 105. The output assembly can include a motor 130, a pump 135, and a hydraulic actuator 140 that acts on the working head 110 to perform the work operation. When the trigger 125 is pressed, electrical current can flow from the battery 120 to output assembly, causing the output assembly to operate the working head 110 to perform the work operation.

In some cases, the trigger 125 can communicate with an electronic controller 190 (e.g., including a processor and a memory) that controls a flow of electrical current from the battery 120 or another power source. More specifically, the electrical current can be provided to the motor 130 of the output assembly. The motor 130 can be coupled to the pump 135 so that rotation of the motor 130 operates the pump 135 to supply pressurized hydraulic fluid to the hydraulic actuator 140. In some cases, the motor 130 can be coupled to the pump 135 via a transmission (e.g., a gear reducer).

Still referring to FIGS. 1-2, the pump 135 can supply hydraulic fluid from a reservoir 145 (e.g., a tank) to a hydraulic cylinder 150. In general, the hydraulic cylinder 150 includes a piston 155 having piston head 160 and a piston rod 165. The piston 155 is moveably received in the cylinder 150 to form a first chamber 170 and a second chamber 175 within an internal volume of the cylinder 150. In some cases, a piston seal is provided to seal between the piston head 160 and the cylinder 150 to prevent fluid from leaking between the first chamber 170 and the second chamber 175. Further, a rod seal is provided to seal between the cylinder 150 and the piston rod 165 to prevent hydraulic fluid from leaking out of the cylinder 150.

To operate the hydraulic actuator 140, the hydraulic cylinder 150 uses pressurized fluid to create mechanical motion. For example, hydraulic fluid is pumped into the first chamber 170. The pressure acting on the surface area of the piston 155 generates a force that causes the piston 155 to move within the cylinder 150 between a first position (e.g., a retracted position or an extended position) and a second position (e.g., the other of the retracted position and the extended position). In some cases, the hydraulic cylinder 150 is single acting. For example, hydraulic fluid is pumped to apply pressure to one side (e.g., first chamber 170) of the piston 155. Therefore, the piston 155 can only move in one direction by the generation of the force. A return mechanism 180 (e.g., spring or gravity) is used to return the piston 155 from the second position to the first position. In other cases, the hydraulic cylinder 150 is double-acting. For example, hydraulic fluid is pumped to apply pressure to both sides (e.g., the first chamber 170 and a second chamber 175) of the piston 155. Hydraulic fluid creates pressure along the surface in the first chamber 170, generating a force to move the piston 155 between the first position and the second position. To move the piston 155 between the second position and the first position, hydraulic fluid creates pressure along the surface in the second chamber 175 to generate a force.

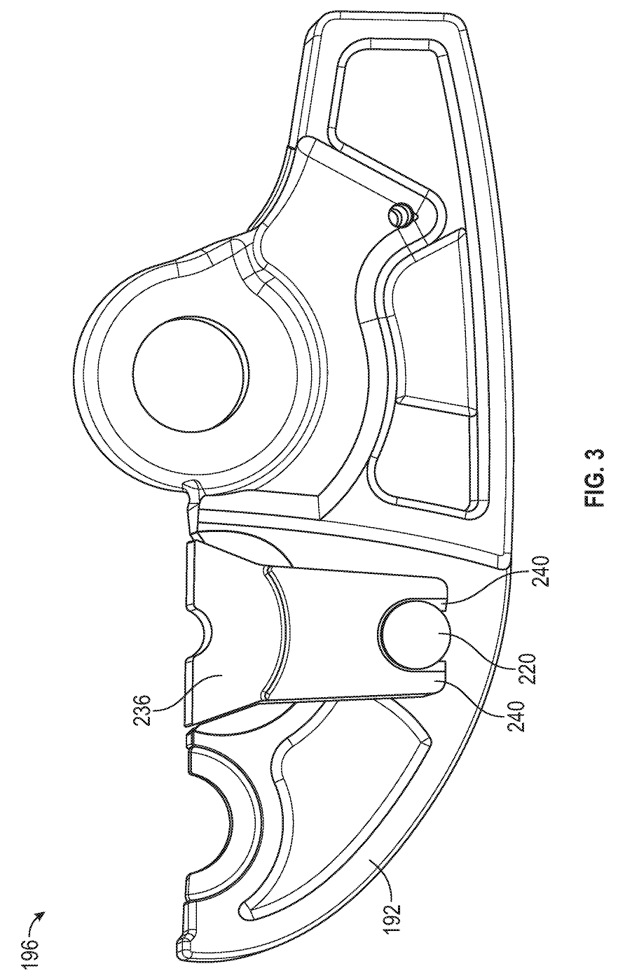

In some examples, the working head 110 can include a pair of jaws 192 (e.g., a pair of moveable jaws, a moveable jaw and a fixed jaw, etc.). The jaws 192 may be configured to receive a die (e.g., a crimping or cutting die, see, e.g., FIG. 3) to permit the jaws to perform a crimp or cut on a workpiece. In some examples, the die may be retained on the jaws 192 via a die retention system 196. In some examples, the die retention system 196 may be configured to permit a user to insert and secure a die on the jaws 192 one-handed, which may increase overall workplace efficiency.

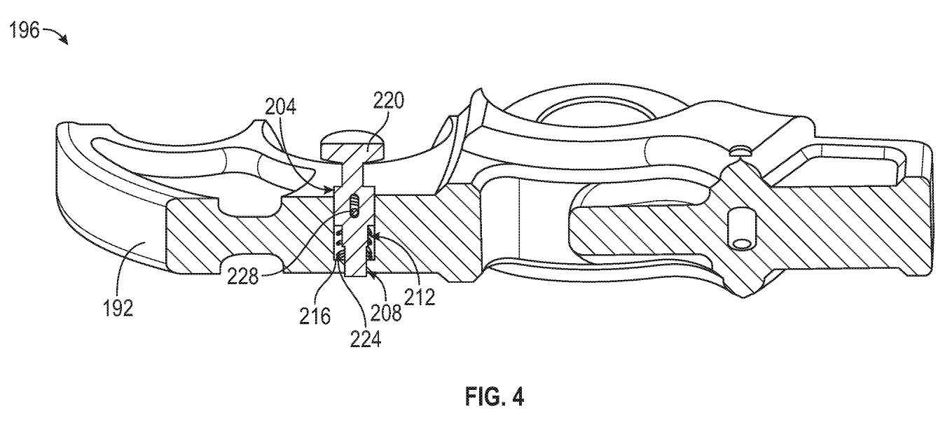

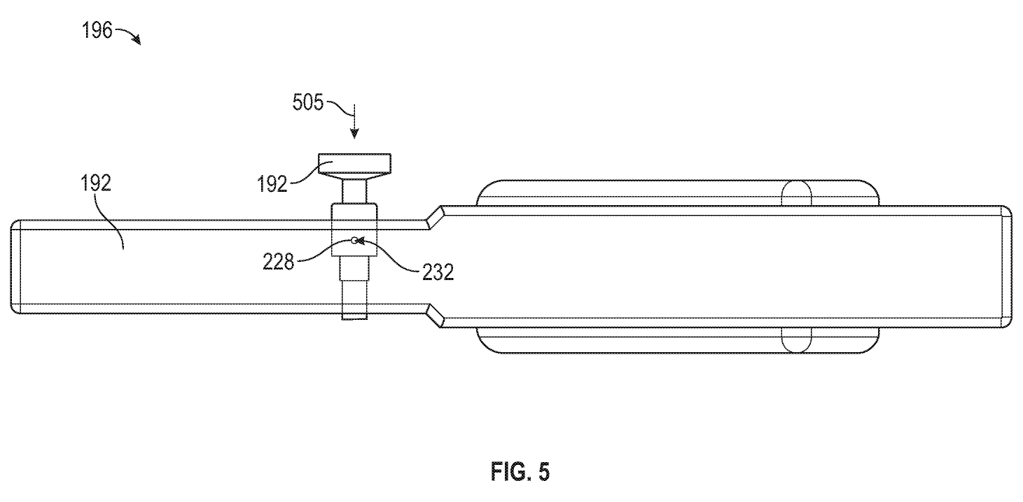

FIGS. 3-5 illustrate an example of the die retention system 196. As mentioned previously, the die retention system 196 may be partially housed with the jaw 192 of the working head 110. Thus, when a die 236 (e.g., a crimping or cutting die, Kearney die, etc.) is installed on the jaw 192, the die retention system 196 may work to retain the die on the jaw. In some examples, to facilitate one-handed installation of the die 236, the die may include one or more fingers 240, which may define a mouth (e.g., opening) at an end of the die 236. In some examples, the fingers 240 may interact with a portion of the die retention system 196 to depress a pin 220 of the die retention system within the jaw 192 (e.g., in the direction shown by arrow 505), which may permit a user to install the die one-handedly. However, to mitigate the risk of unintentional removal of the die 236, removal of the die 236 may be a two-handed operation. As should be appreciated, each of the jaws 192 may include a die retention system 196. However, for ease of disclosure, only a single jaw 192 and corresponding die retention system 196 will be described.

In some examples, in order to receive and secure the die retention system 196, the jaw 192 may include a thru-hole 212 extending from a first side of the jaw to a second side of the jaw. For example, the thru-hole may define a first opening 204 on a first side of the jaw 192 and a second opening 208 on a second side of the jaw 192, opposite of the first opening 204. In some examples, to retain one or more components of the die retention system 196 within the thru-hole 212, the thru-hole may include an internal ledge 216. Correspondingly, the first opening 204 may have a larger diameter than the second opening 208.

In some examples, the die retention system 196 may include a pin 220, a biasing element (e.g., a spring) 224, and a dowel rod 228. In some examples, during installation, the biasing element 224 may first be arranged within the thru-hole 212, with an end of the biasing element contacting the ledge 216. Correspondingly, the pin 220 may be arranged within the thru-hole 212. In some examples, the pin 220 may be moveably retained within the thru-hole 212 via the dowel rod 228. For example, the dowel rod 228 may be installed through a dowel rod channel 232 formed in the jaw 192 (e.g., after the installation of the pin 220).

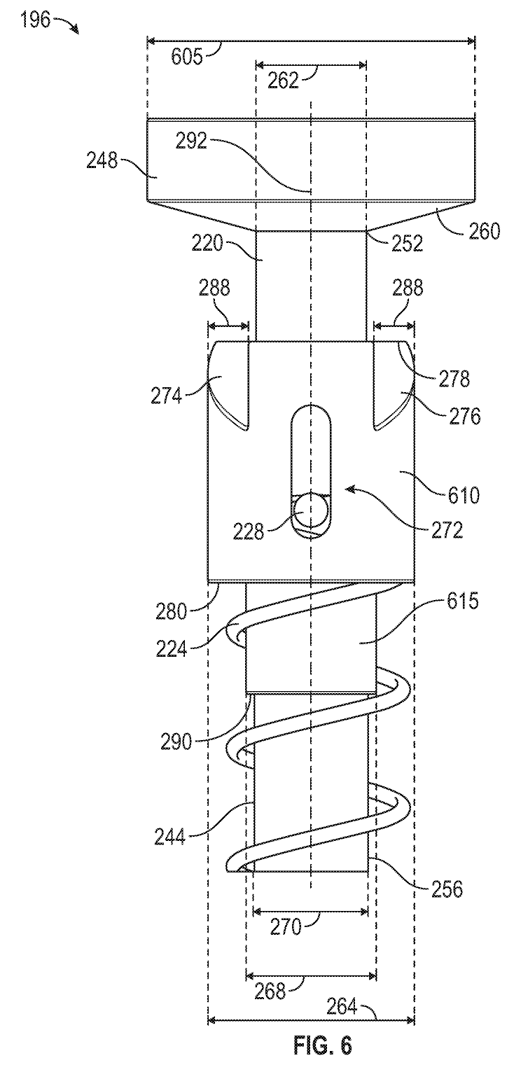

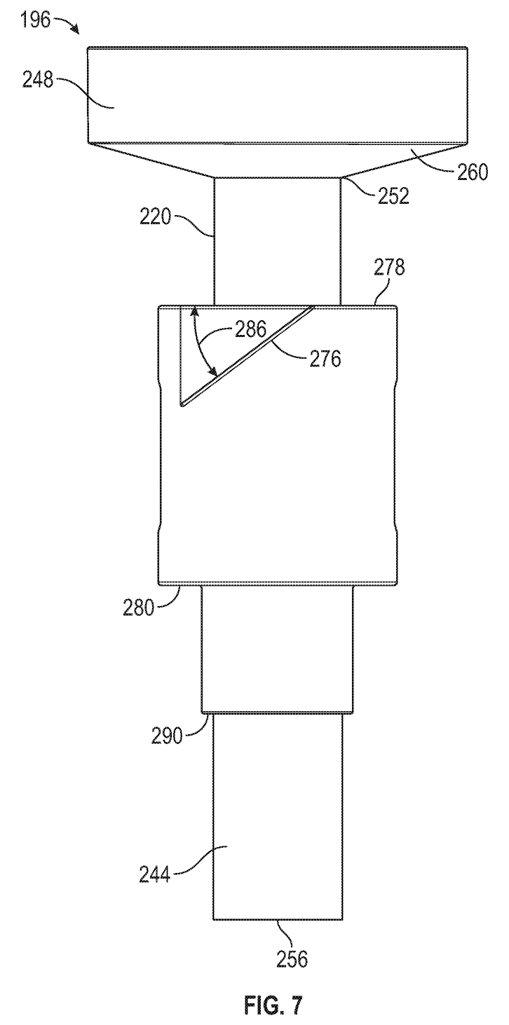

FIGS. 6 and 7 illustrate an example of the die retention system 196. As mentioned previously, the die retention system 196 may include the pin 220, the biasing element 225, and the dowel rod 228. In some examples, the pin 220 may include a body 244 and a head 248. The body 244 may include a first end 252 and a second end 256 opposite of the first end 252. The head 248 may be fixed at the first end 252 of the body 244. In some examples, the head 248 may be cylindrical in shape (e.g., have a circular cross-section). Further, the connection between the first end 252 of the body 244 and the head 248 may be chamfered (e.g., chamfer 260) to provide a smooth transition surface between the body 244 and the head 248. In other examples, the head 248 may be shaped differently (e.g., may define a rectangular, triangular, or other polygonal cross-sectional shape).

In some examples, the body 244 of the pin 220 may include a number of varying diameters along a length of the body 244. For example, starting at the first end 252 and moving towards the second end 256, the body 244 may define a first diameter 262, a second diameter 264, a third diameter 268, and a fourth diameter 270. Further, the head 248 may define a fifth diameter 605. In some examples, the fifth diameter 605 (e.g., of the head 248) may be the largest diameter. Following this, the next largest diameter may be the second diameter 264, followed by the third diameter 268. Finally, the first diameter 262 and the fourth diameter 270 may be the smallest diameter, with the first and third diameters being substantially equivalent.

In some examples, the first diameter 262 corresponds to a first portion (e.g., a neck) of the body 244, which extends from the head 248 to a ramp assembly 610. The second diameter 264 may correspond to the ramp assembly 610, which may define a slot 272 (e.g., to receive the dowel rod 228) and one or more ramps 274, 276. In some examples, the ramp assembly 610 may be bounded at a first end by a first ledge 278 (e.g., adjacent the first portion of the body) and at a second end by a retention ledge 280. In some examples, the slot 272 may extend through the ramp assembly 610 so as to receive the dowel rod 228. In some examples, the slot 272 may be located between the ramps 274, 276 (e.g., along a central axis 292 of the pin 220).

In some examples, the ramps 274, 276 may be positioned at an end of the ramp assembly 610 nearer the head 248 of the pin 220. Further, the ramps 274, 276 may extend at an angle 286 from the first ledge 278 (e.g., extend between about 35 to about 40 degrees from the first ledge 278). However, in other examples, the ramps may extend at any other angle (e.g., from about 5 degrees to about 75 degrees). In some examples, a width 288 of each of the ramps 274, 276 may form a difference in diameter between the ramp assembly 610 and the first diameter 262 of the first portion of the body 244.

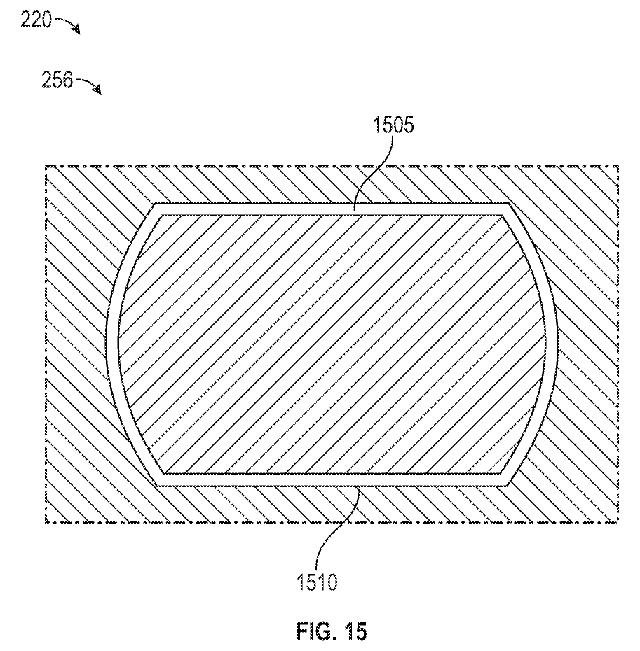

In some examples, the third diameter 268 may correspond to a travel stop 615 of the body 244. For example, the travel stop 615 may extend from the ramp assembly 610 to a ridge 290. In some examples, the ridge 290 may be configured to contact the ledge 216 during actuation of the pin 220 to mitigate over-travel of the pin 220. Thus, the third diameter 268 may be larger than a diameter of the second opening 208. In some examples, the fourth diameter 270 may be substantially similar to the first diameter 262 and correspond to the second end 256 of the body 244. In some examples, to mitigate unwanted rotation of the pin 220 within the jaw 192, the second end 256 of the pin 220 may be keyed (e.g.,, with a single flat side, a double-D shape, non-circular cross-section, etc.) to the second opening 208 to mitigate rotation of the pin 220 within the jaw 192. For example, as shown in FIG. 15, the second end 256 of the pin 220 may include a first planar side 1505 and a second planar side 1510 (e.g., forming a double-D shape). However, in other examples, if rotation of the pin 220 is desired, the second end 256 of the pin 220 and the second opening 208 may instead define a substantially circular cross-section.

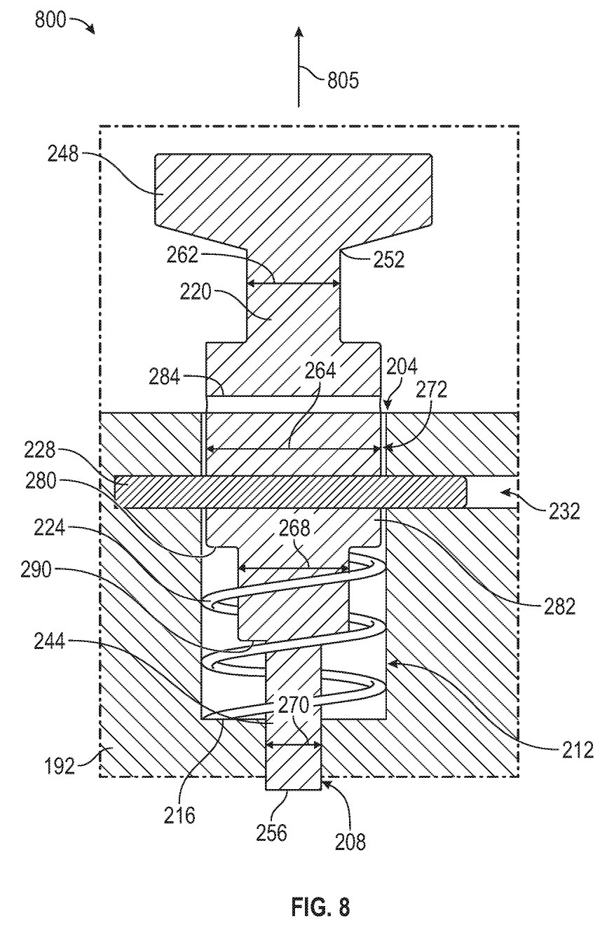

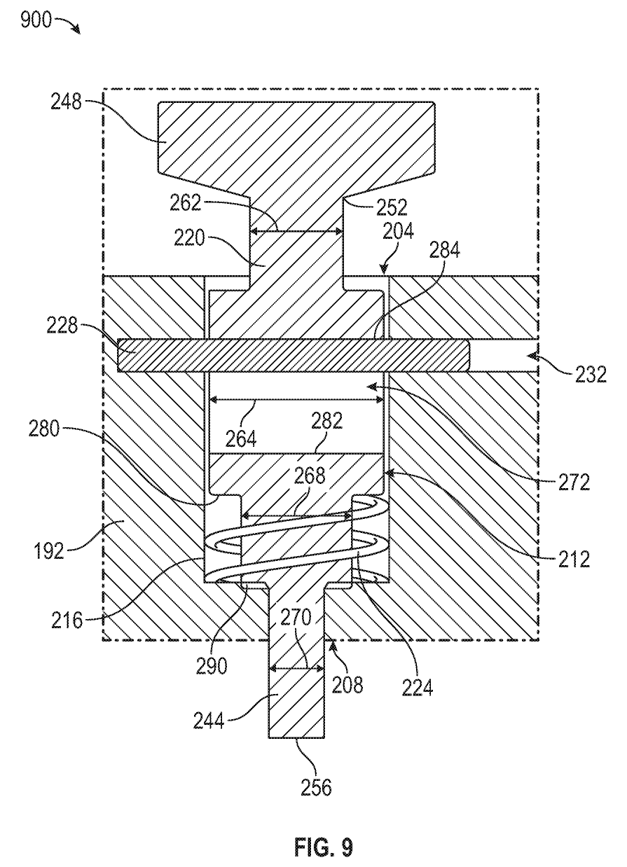

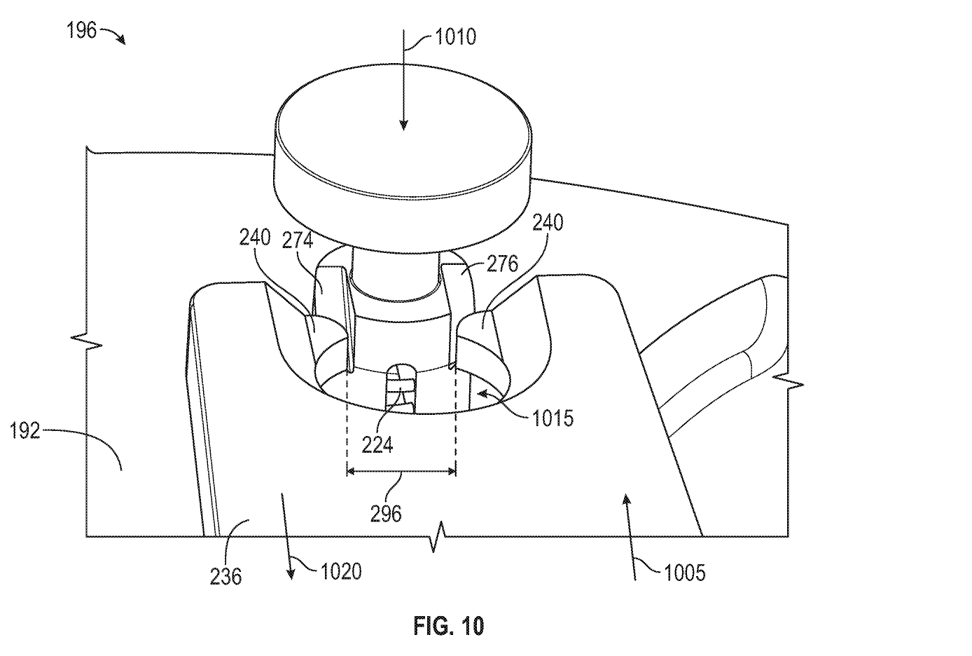

FIGS. 8-10 show an example of the die retention system 196 in use (e.g., during an installation process of the die 236). In some examples, prior to contact between the die 236 and the pin 220, the die retention system 196 may be in a first (e.g., home) position 800. In the first position 800, the biasing element 224 may be positioned between the retention ledge 280 and the ledge 216 of the jaw 192 to provide a biasing force in the direction shown by arrow 805 to the pin 220. Correspondingly, to mitigate upward (e.g., in the direction shown by arrow 805) movement of the pin 220, the dowel rod 228 may contact a first end 282 of the slot 272, which may form a first movement stop for the die retention system. Further, when in the first position 800, the second end 256 of the pin 220 may extend within and partially through the second opening 208 in the jaw 192.

In some examples, in order to install the die 236 on the jaw 192, an operator may first align the fingers 240 and corresponding mouth 296 (e.g., formed between the fingers 240) with the ramps 274, 276 of the pin 220, with the die retention system 196 in the first position 800. Following this, the operator may apply a force to the die 236 in the direction shown by arrow 1005. In some examples, as the die 236 moves in the direction shown by arrow 1005 the fingers 240 may contact the ramps 274, 276 and apply a corresponding force in the direction shown by arrow 1010 to the pin 220 (e.g., to depress the pin 220 within the jaw 192), which moves the die retention system 196 into a second position 900.

In some examples, in the second position 900 (e.g., a compressed position), the force applied to the pin 220 may compress the biasing element 224 between the retention ledge 280 and the ledge 216 until the dowel rod 228 contacts a second end 284 of the slot 272. In some examples, when in the second position 900, the ridge 290 of the pin 220 may contact the ledge 216 of the jaw 192 (e.g., forming a second movement stop of the die retention system). Further, when in the second position 900, the second end 256 of the pin 220 may extend further through the second opening 208 in the jaw 192 vs. when in the first position 800.

In some examples, during installation of the die 236, once the fingers 240 of the die 236 pass the ramps 274, 276, the biasing force provided by the biasing element 224 may automatically return the pin 220 to the first position 800. In some examples, the mouth 296 formed between the fingers 240 of the die 236 may be narrower than an aperture 1015 formed in the die 236. Thus, once the fingers 240 bypass the ramps 274, 276, the pin 220 may move into the first position 800, with the ramp assembly 610 arranged within the aperture 1015 of the die 236. In some examples, as the diameter of the ramp assembly 610 is larger than the width of the mouth 296, the die 236 may be secured to the jaw 192.

In some examples, in order to remove the die 236, an operator may need to apply a force to the pin 220 in the direction shown by arrow 1010 (e.g., to move the pin 220 from the first position 800 to the second position 900), which may align the smaller diameter first portion (e.g., corresponding to first diameter 262) with the mouth 296. Following this, the operator may apply a force to the die 236 in the direction shown by arrow 1020 to slide the first portion of the pin through the mouth 296 and remove the die 236 from the jaw 192.

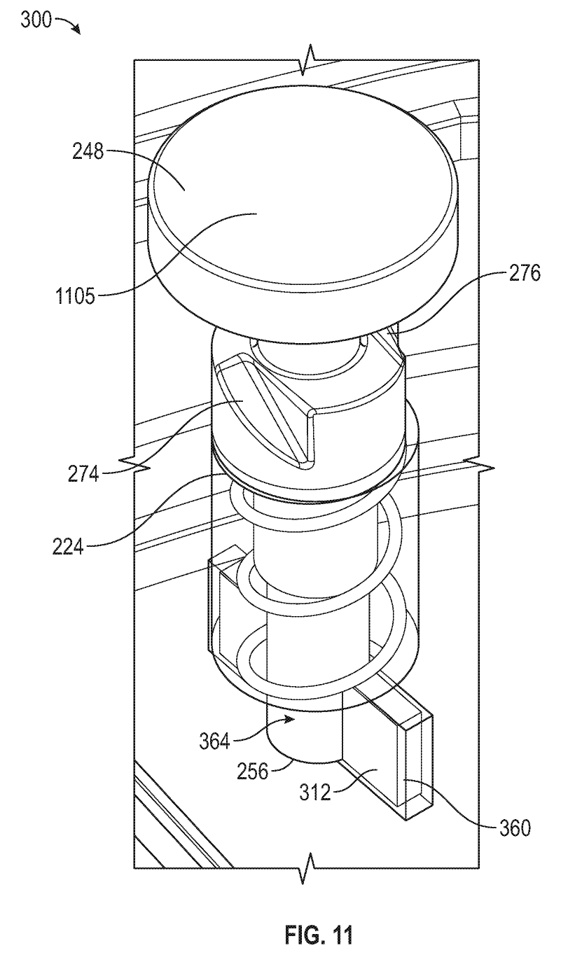

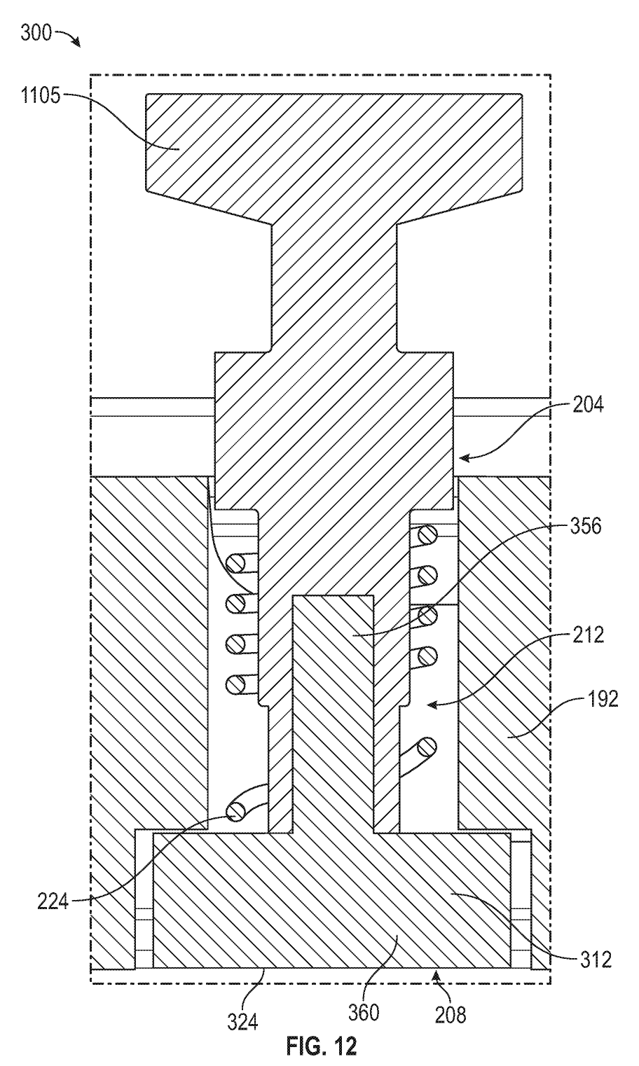

FIGS. 11 and 12 illustrate another example of a die retention system 300 that can be used with the hydraulic tool 100 of FIG. 1 (e.g., as an alternative configuration of the die retention system 196). As will be recognized, the die retention system 300 shares a number of components in common with and operates in a similar fashion to the examples illustrated and described previously. For the sake of brevity, these common features will not be again described below in detail. Rather, previous discussion of commonly named or numbered features, unless otherwise indicated, also applies to example configurations of the die retention system 300.

In some examples, the die retention system 300 may include a pin 1105, which may include a key 312 at the second end 256. In some examples, the key 312 may include a stem 356 that extends into pin 1105 from the second end 256 of the pin 1105. Further, in some examples, a crossbar 360 may extend substantially perpendicular to the stem 356 (e.g., to form a substantially T-shaped key). In some examples, the crossbar 360 may be arranged within a slot 364 formed in the second end 256 of the pin 1105.

In some examples, the key 312 may form a travel stop (e.g., a lower travel stop) for the die retention system 300. For example, when the die retention system 300 is arranged within the jaw 192, the second end 256 of the pin 1105 may contact the key 312 to mitigate movement of the pin 1105. Further, the key 312 may additional be used as an anti-rotation feature to mitigate rotation of the pin 1105 within the jaw 192.

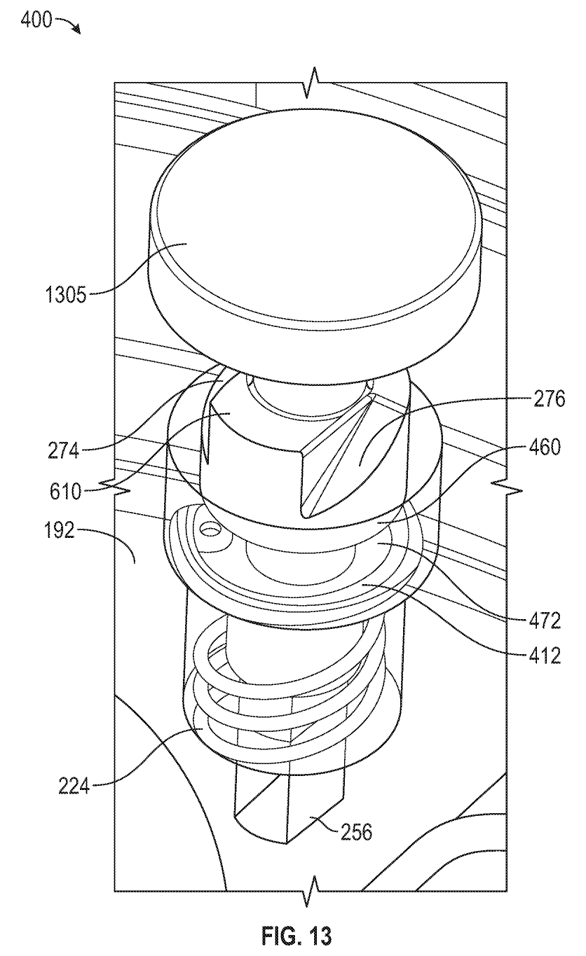

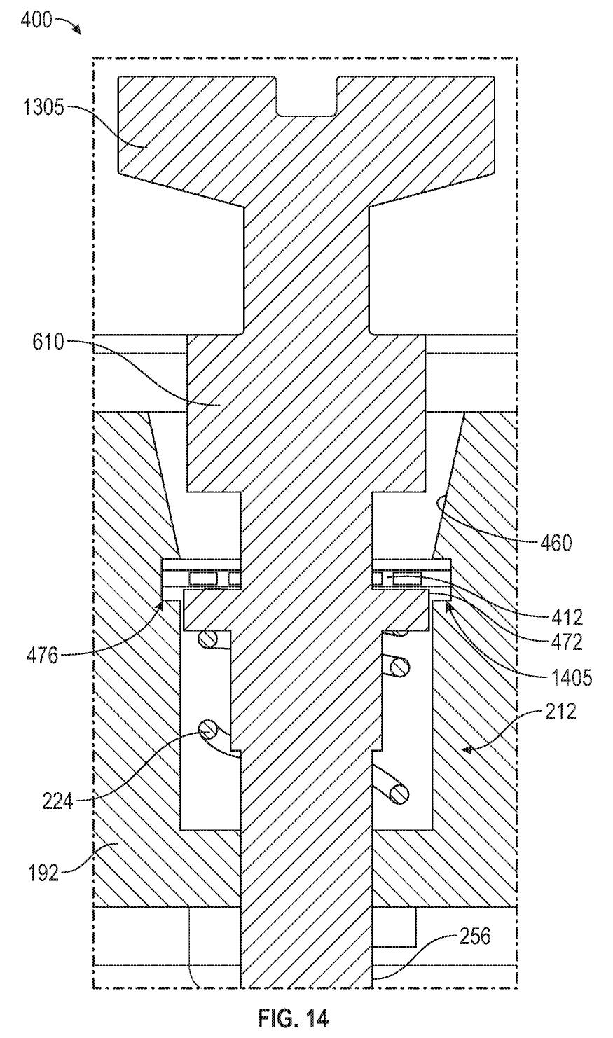

FIGS. 13 and 14 illustrate another example of a die retention system 400 that can be used with the hydraulic tool 100 of FIG. 1 (e.g., as an alternative configuration of the die retention system 196). As will be recognized, the die retention system 400 shares a number of components in common with and operates in a similar fashion to the examples illustrated and described previously. For the sake of brevity, these common features will not be again described below in detail. Rather, previous discussion of commonly named or numbered features, unless otherwise indicated, also applies to example configurations of the die retention system 400.

In some examples, the die retention system 400 may include a pin 1305. The pin 1305 may be retained within the jaw 192 via a retaining clip 412. For example, the retaining clip 412 may be arranged within a circumferential groove 476 of the pin 1305. In some examples, the groove 476 may be formed between the ramp assembly 610 and a flange 472 extending from the pin 1305. Thus, as the pin 1305 is moved between the first and second positions 800, 900, the pin 1305 may slide with respect to the retaining clip 412. However, the retaining clip 412 may serve as a travel stop (e.g., an upper travel stop) to mitigate movement of the pin 1305. For example, the retaining clip 412 may contact the flange 472 when in the first position 800 to mitigate movement of the pin 1305.

In some examples, in order to permit installation of the retaining clip 412, the thru-hole 212 may include a lead-in chamfer 460, which may guide the retaining clip 412 into a cutout 1405 formed on an interior surface of the thru-hole 212 and configured to secure the retaining clip 412.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ± 12 degrees of a reference direction (e.g., within ± 6 degrees), inclusive.

Also as used herein, unless otherwise limited or defined, “substantially perpendicular” indicates a direction that is within ± 12 degrees of perpendicular a reference direction (e.g., within ± 6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ± 15% or less, inclusive of the endpoints of the range. Similarly, the term “substantially equal” (and the like) as used herein with respect to a reference value refers to variations from the reference value of less than ± 10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the above description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A die retention system for a hydraulic tool, comprising:
a jaw defining a thru-hole extending from a first side to a second side of the jaw;
a pin moveably retained within the thru-hole, the pin being movable between a first position and a second position via interaction between a portion of a die and a ramped surface of the pin;
a biasing element arranged within the thru-hole to apply a biasing force to the pin to maintain the pin in the first position; and
a dowel rod installed through the pin to retain the pin within the thru-hole.

2. The die retention system of claim 1, wherein the thru-hole includes an internal ledge, and wherein the biasing element is positioned between the internal ledge and a retention ledge of the pin.

3. The die retention system of claim 1, wherein the pin includes a body and a head, the body defining a slot to receive the dowel rod.

4. The die retention system of claim 3, wherein the slot includes a first end and a second end, the first end contacting the dowel rod when the pin is in the first position, and the second end contacting the dowel rod when the pin is in the second position.

5. The die retention system of claim 3, wherein the body of the pin includes a keyed end to mitigate rotation of the pin within the thru-hole.

6. The die retention system of claim 5, wherein the keyed end has at least one planar side.

7. The die retention system of claim 1, wherein the biasing element is a spring.

8. The die retention system of claim 1, wherein the pin secures the die to the jaw when in the first position and permits removal of the die from the jaw when in the second position.

9. The die retention system of claim 2, wherein the pin includes a travel stop having a ridge configured to contact the internal ledge of the thru-hole to mitigate over-travel of the pin when in the second position.

10. The die retention system of claim 1, wherein the die includes one or more fingers defining a mouth, and wherein the one or more fingers are configured to interact with the ramped surface to move the pin from the first position to the second position during installation of the die.

11. A method of installing a die onto a jaw of a hydraulic tool, the method comprising:
aligning the die with a ramped surface of a pin moveably retained within a thru-hole of the jaw;
applying a force to the die to cause the die to contact the ramped surface and move the pin from a first position within the jaw to a second position within the jaw, against a biasing force of a biasing element; and
once the die is seated on the jaw, moving the pin from the second position to the first position via the biasing force from the biasing element to secure the die to the jaw.

12. The method of claim 11, wherein aligning the die includes aligning one or more fingers of the die with the ramped surface of the pin.

13. The method of claim 11, wherein the pin is retained within the thru-hole by a dowel rod installed through a slot in the pin.

14. The method of claim 13, wherein the slot includes a first end and a second end, the first end contacting the dowel rod when the pin is in the first position, and the second end contacting the dowel rod when the pin is in the second position.

15. The method of claim 11, wherein the biasing element is a spring positioned between an internal ledge of the thru-hole and a retention ledge of the pin.

16. A die retention system for a hydraulic tool, comprising:
a jaw defining a thru-hole extending from a first opening on a first side of the jaw to a second opening on a second side of the jaw, the thru-hole including an internal ledge on an internal surface of the thru-hole;
a pin moveably retained within the thru-hole, the pin including a body and a head, the body defining a ramp assembly having one or more ramps and a slot, the pin being movable between a first position and a second position via interaction between a portion of a die and the one or more ramps;
a biasing element arranged within the thru-hole and positioned between the internal ledge and a retention ledge of the pin to apply a biasing force to the pin to bias the pin into the first position; and
a dowel rod installed through the slot of the pin to retain the pin within the thru-hole.

17. The die retention system of claim 16, wherein the slot includes a first end and a second end, the first end contacting the dowel rod when the pin is in the first position, and the second end contacting the dowel rod when the pin is in the second position.

18. The die retention system of claim 16, wherein the body of the pin includes a keyed end having at least one planar side to mitigate rotation of the pin within the thru-hole.

19. The die retention system of claim 16, wherein the pin includes a travel stop having a ridge configured to contact the internal ledge of the thru-hole to mitigate over-travel of the pin when in the second position.

20. The die retention system of claim 16, wherein the die includes one or more fingers defining a mouth, and wherein the one or more fingers are configured to interact with the one or more ramps to depress the pin from the first position to the second position during installation of the die.
